(19) United States
(12) Patent Application Publication
(10) Pub. No.: US 2026/0226709 A1
(43) Pub. Date: Aug. 6, 2026

(54) SYSTEM FOR CONTROLLING WORK MACHINE, WORK MACHINE, AND METHOD FOR CONTROLLING WORK MACHINE

(71) Applicant: KOMATSU LTD., Tokyo (JP)

(72) Inventor: Makoto Nomura, Tokyo (JP)

(73) Assignee: KOMATSU LTD., Tokyo (JP)

(21) Appl. No.: 19/147,835

(22) PCT Filed: Jan. 24, 2024
(86) PCT No.: PCT/JP2024/002044

§ 371 Date: Jul. 14, 2025

(30) Foreign Application Priority Data
Jan. 31, 2023 (JP) 2023-013292

(51) Int. Cl. E02F 9/20; E02F 9/22

(52) U.S. Cl. CPC E02F 9/2091; E02F 9/2033; E02F 9/207; E02F 9/2296

(57) ABSTRACT

A system for controlling a work machine that includes a work implement and is driven by electricity from a power storage device includes an operation device configured to operate the work implement and a controller. The controller acquires an operation command from the operation device, detects a remaining amount of power stored in the power storage device, and outputs a control signal to slow a rise of an operation speed of the work implement in response to the operation command from the operation device when it is determined that the detected remaining amount of power stored in the power storage device is equal to or less than a predetermined threshold.

### TECHNICAL FIELD

The present disclosure relates to a system for controlling a work machine, a work machine, and a method for controlling a work machine.

### BACKGROUND ART

A known battery-driven hydraulic work machine can generate an alarm when a detection value detected by a remaining battery charge detection means reaches a battery set value, continuously operates an actuator after the warning is generated, when the detection value reaches a different battery set value, stop the operation of the actuator or an electrical motor, decrease the operation speed of the actuator, or decrease the rotation speed of the electrical motor, and thus allows an operator to recognize that the battery is almost empty and the hydraulic work machine needs to be moved to a charging facility.

### CITATION LIST

### Patent Literature

Patent Document 1: JP 11-107320 A

### SUMMARY OF INVENTION

### Technical Problem

The technology described in Patent Document 1 generates, when a remaining amount of power stored in the battery is low, an alarm for notifying that the remaining amount of power is low, but there is still a margin of the remaining amount of power for moving the hydraulic work machine to the charging facility. That is, if the work can be continued to some extent even after generation of the alarm, the operator operating the machine is likely to take a margin of the remaining amount of power into account and continue the work. This may cause the alarm not to have an original function.

An object of the present disclosure is to prompt an operator to perform charging when the remaining amount of power stored in a power storage device is low.

### Solution to Problem

A system for controlling a work machine according to the present disclosure is a system for controlling a work machine that includes a work implement and is driven by electricity from a power storage device. The system includes an operation device configured to operate the work implement and a controller. The controller acquires an operation command from the operation device. The controller detects a remaining amount of power stored in the power storage device. The controller controls the work implement to slow a rise of an operation speed of the work implement in response to the operation command from the operation device when it is determined that the detected remaining amount of power stored in the power storage device is equal to or less than a predetermined threshold.

A work machine according to the present disclosure includes a work implement, a power storage device, an operation device configured to operate the work implement, and a controller. The controller acquires an operation command from the operation device. The controller detects a remaining amount of power stored in the power storage device. The controller controls the work implement to slow a rise of an operation speed of the work implement in response to the operation command from the operation device when it is determined that the detected remaining amount of power stored in the power storage device is equal to or less than a predetermined threshold.

A method for controlling a work machine according to the present disclosure is a method for controlling a work machine driven by electricity from a power storage device. The method includes acquiring an operation command from an operation device configured to operate a work implement, detecting a remaining amount of power stored in the power storage device, and controlling the work implement to slow a rise of an operation speed of the work implement in response to the operation command from the operation device when it is determined that the detected remaining amount of power stored in the power storage device is equal to or less than a predetermined threshold.

### Advantageous Effects of Invention

The present disclosure can prompt an operator to perform charging when the remaining amount of power stored in a power storage device is low.

### BRIEF DESCRIPTION OF DRAWINGS

FIG. 1 is a perspective view schematically illustrating a configuration of a work machine according to a first embodiment.

FIG. 2 is a diagram schematically illustrating a configuration for controlling the work machine according to the first embodiment.

FIG. 3 is a block diagram illustrating a computer system according to the first embodiment.

FIG. 4 is a diagram showing an example of work implement operation when the remaining amount of power stored in a power storage device has not decreased to a predetermined threshold, according to the first embodiment.

FIG. 5 is a diagram showing an example of work implement operation when the remaining amount of power stored in the power storage device has decreased to the predetermined threshold, according to the first embodiment.

FIG. 6 is a flowchart illustrating an example of a method for controlling the work machine according to the first embodiment.

FIG. 7 is a diagram showing a variation of work implement operation when the remaining amount of power stored in the power storage device has decreased to the predetermined threshold.

FIG. 8 is a diagram showing a variation of work implement operation when the remaining amount of power stored in the power storage device has decreased to the predetermined threshold.

FIG. 9 is a diagram showing a variation of work implement operation when the remaining amount of power stored in the power storage device has decreased to the predetermined threshold.

FIG. 10 is a diagram schematically illustrating a configuration for controlling a work machine according to a second embodiment.

FIG. 11 is a diagram schematically illustrating a configuration for controlling a work machine according to a third embodiment.

### DESCRIPTION OF EMBODIMENTS

Embodiments of the present disclosure will be described below with reference to the drawings, but the present disclosure is not limited to the embodiments. The components of the embodiments described below can be combined as appropriate. In addition, some components may not be used in some cases.

In the embodiments, an electrically driven hydraulic excavator using a battery (i.e., a power storage device) as a power source will be described as an example of a work machine. However, the present disclosure is also applicable to work machines other than the excavator, such as a forklift, a wheel loader, a bulldozer, and a dump truck.

### First Embodiment

### Work Machine

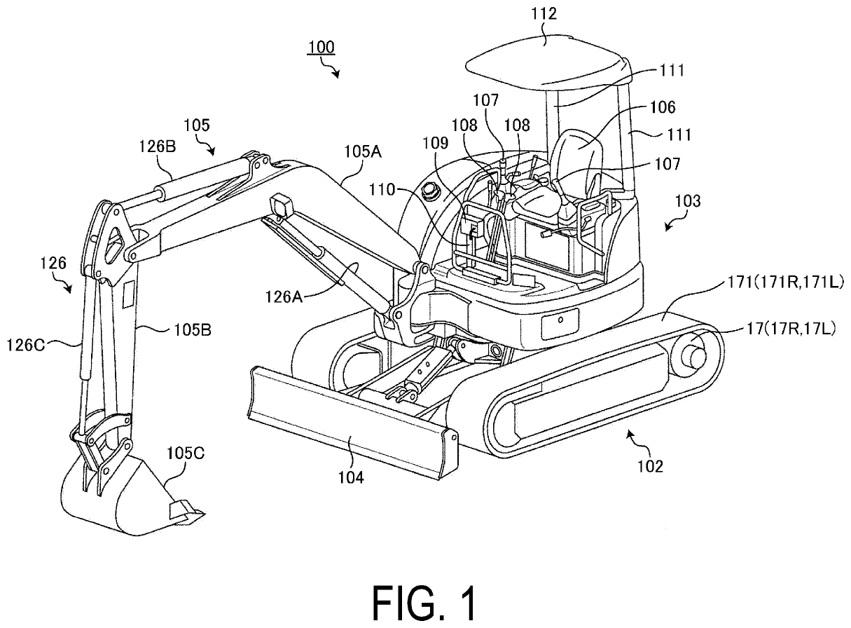

FIG. 1 is a perspective view schematically illustrating a configuration of a work machine according to a first embodiment. As illustrated in FIG. 1, a work machine 100 according to the embodiment is a hydraulic excavator, for example.

The work machine 100 includes a travel body 102, a revolution body 103, and a work implement 105. The travel body 102 includes a travel motor 17 and continuous tracks 171. The continuous tracks 171 include a right continuous track 171R and a left continuous track 171L. The work machine 100 can travel by rotation of the continuous tracks 171. The work machine 100 may include tires instead of the continuous tracks 171.

The revolution body 103 is revolvably supported by the travel body 102. The work implement 105 is pivotably connected to the revolution body 103. The work implement 105 includes a boom 105A, an arm 105B, and a bucket 105C. The work implement 105 is driven by a cylinder 18 described later. The revolution body 103 includes a cab 112. An operation device 5 is provided in the cab 112. The work machine 100 includes a system 1.

### System

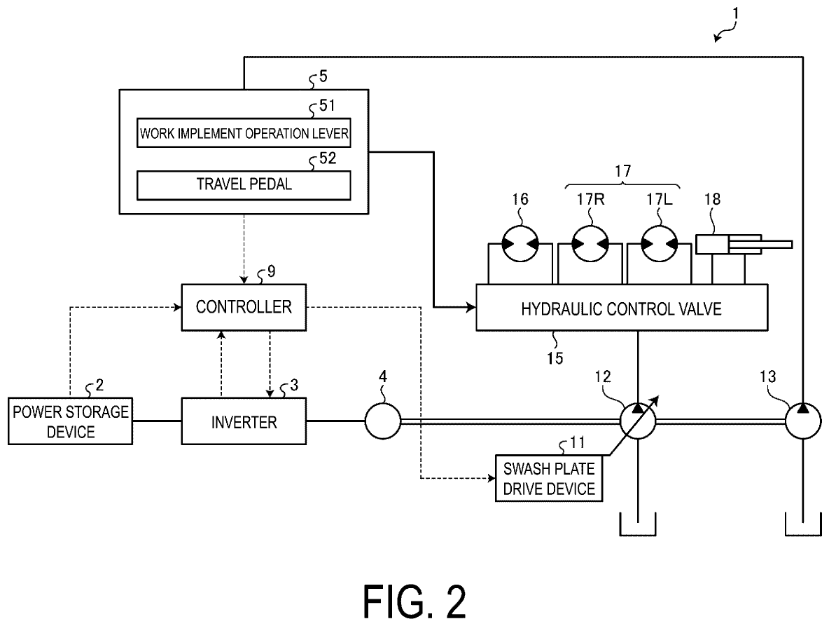

FIG. 2 is a diagram schematically illustrating a configuration for controlling the work machine according to the first embodiment. The system 1 is a system for controlling the work machine 100 driven by electricity from a power storage device 2. The system 1 includes a controller 9 including at least one or more processors.

As illustrated in FIG. 2, the system 1 includes the power storage device 2, an inverter 3, an electric motor 4 that is an electrical motor, the operation device 5, and the controller 9. The system 1 further includes a main hydraulic pump 12, a pilot hydraulic pump 13, a hydraulic control valve 15, a revolution motor 16, the travel motor 17, and the cylinder 18. In the embodiment, the revolution motor 16, the travel motor 17, and the cylinder 18 are hydraulic actuators that are driven by hydraulic oil supplied from the main hydraulic pump 12, but are not limited thereto. The revolution motor 16, the travel motor 17, and the cylinder 18 may be, for example, electric actuators that are driven by electricity from the power storage device 2.

In the work machine 100, the revolution body 103 is revolved by the revolution motor 16. The work machine 100 travels by the continuous tracks 171 rotationally driven by the travel motor 17. In the work machine 100, the work implement 105 is actuated by the cylinder 18. In the embodiment, the work machine 100 includes a right travel motor 17R and a left travel motor 17L for rotationally driving the right continuous track 171R and the left continuous track 171L.

The power storage device 2 supplies electricity for driving the work machine 100. The power storage device 2 outputs, to controller 9, state of charge (SOC) data indicating the remaining amount of power.

The inverter 3 supplies electricity from the power storage device 2 to the electric motor 4. The inverter 3 supplies electricity to the electric motor 4 based on a motor control command signal from the controller 9. The inverter 3 controls the electric motor 4 based on the motor control command signal from the controller 9.

The electric motor 4 is driven by electricity from the power storage device 2. The electric motor 4 is a drive source of the work machine 100. The electric motor 4 supplies driving power for driving the work machine 100. The electric motor 4 drives the main hydraulic pump 12, the pilot hydraulic pump 13, and the like. The electric motor 4 outputs driving power to the main hydraulic pump 12, the pilot hydraulic pump 13, and the like.

The operation device 5 is an operator input device for operating the work machine 100. The operation device 5 includes, for example, a work implement operation lever 51 and a travel operation pedal 52.

The work implement operation lever 51 is a work implement operation device for controlling the work implement 105. The work implement operation lever 51 is operated by an operator to control, for example, each of the boom 105A, the arm 105B, and the bucket 105C. The operator operates the work implement operation lever 51 to control the operation speed of the cylinders 18 that drive the boom 105A, the arm 105B, and the bucket 105C. The work implement operation lever 51 includes a lever operation amount sensor (not illustrated). The lever operation amount sensor is, for example, a pilot pressure sensor that detects a pilot pressure that changes depending on the operation amount. The lever operation amount sensor outputs, to the controller 9, an operation command indicating the operation amount of the work implement operation lever 51.

Although the work implement operation lever 51 is illustrated in FIG. 2, any number of operation levers may be provided. The work implement operation lever 51 may include operation levers associated with the boom 105A, the arm 105B, and the bucket 105C, respectively. The work implement operation lever 51 may be associated with the revolution operation of the revolution body 103 relative to the travel body 102. The work implement operation lever 51 may include a dual purpose operation lever used for a combination of any two selected from operation of the boom 105A, operation of the arm 105B, the operation of the bucket 105C, and revolution operation of the revolution body 103.

The travel operation pedal 52 is a travel operation device for controlling travel of the work machine 100. For example, the travel operation pedal 52 is operated by the operator to control the travel speed of the work machine 100. The operator controls the rotation speed of the travel motor 17 by operating the travel operation pedal 52. The travel operation pedal 52 includes a pedal operation amount sensor (not illustrated). The pedal operation amount sensor may include, for example, a potentiometer. The pedal operation amount sensor outputs, to the controller 9, an operation command indicating an operation amount of the travel operation pedal 52.

The main hydraulic pump 12 supplies the hydraulic oil for driving the work implement 105. The main hydraulic pump 12 is driven by the electric motor 4 and discharges the hydraulic oil. The main hydraulic pump 12 is, for example, a variable displacement hydraulic pump in which discharge volume can be varied by a tilt angle of a swash plate. The main hydraulic pump 12 includes a swash plate drive device 11 for controlling the tilt angle of the swash plate. Based on a control command signal from the controller 9, the swash plate drive device 11 controls the flow rate of the hydraulic oil discharged from the main hydraulic pump 12. The swash plate drive device 11 controls the tilt angle of the swash plate of the main hydraulic pump 12. The swash plate drive device 11 is, for example, a proportional solenoid valve, and controls the tilt angle of the swash plate of the main hydraulic pump 12, based on the flowing current from the controller 9. The hydraulic oil discharged from the main hydraulic pump 12 is supplied to the revolution motor 16, the travel motor 17, and the cylinder 18 via a hydraulic circuit.

The pilot hydraulic pump 13 supplies the hydraulic oil to the operation device 5.

The hydraulic control valve 15 is a flow/directional control valve. The hydraulic control valve 15 includes a spool (not illustrated) that moves in accordance with an operation direction of each operation lever of the operation device 5, and thereby realizes control of a flow rate and a flow direction of hydraulic oil flowing to each hydraulic actuator. The hydraulic control valve 15 supplies the hydraulic oil in accordance with an operation amount of the operation device 5, to a hydraulic actuator such as the revolution motor 16, the travel motor 17, or the cylinder 18.

The revolution motor 16 is a motor for revolution that generates a driving force for revolving the revolution body 103. The revolution motor 16 is driven by the hydraulic oil discharged from the main hydraulic pump 12.

The travel motor 17 is a motor for traveling that generates a driving force for rotating the continuous tracks 171. The travel motor 17 is driven by the hydraulic oil discharged from the main hydraulic pump 12. The speed and direction of rotation of the travel motor 17 are changed in accordance with the discharge direction of the hydraulic oil from the main hydraulic pump 12.

The cylinder 18 is a cylinder for driving the work implement 105. The cylinder 18 is driven by the hydraulic oil discharged from the main hydraulic pump 12. The cylinder 18 is, for example, a boom cylinder 126A, an arm cylinder 126B, or a bucket cylinder 126C.

The controller 9 includes at least one or more processors. The controller 9 is an electronic control unit including an arithmetic device such as a central processing unit (CPU), various memories, and the like. The controller 9 is electrically connected to each of the power storage device 2, the inverter 3, the swash plate drive device 11, and the operation device 5.

The controller 9 detects the remaining amount of power stored in the power storage device 2. The controller 9 acquires, from the power storage device 2, the state of charge data indicating the remaining amount of power stored in the power storage device 2.

The controller 9 acquires an operation command from the operation device 5. More specifically, the controller 9 acquires a work implement operation command from the work implement operation lever 51. The controller 9 acquires a travel operation command from the travel pedal 52.

The controller 9 controls the rotation speed of the electric motor 4 by controlling the inverter 3 in response to an operation command from the operation device 5. The controller 9 controls the rotation speed of the electric motor 4 by, for example, adjusting a target value or a gain of the rotation speed of the electric motor 4 and controlling a motor current supplied to the electric motor 4.

The controller 9 controls the main hydraulic pump 12 in response to an operation command from the operation device 5, by outputting, to the swash plate drive device 11, a control command signal for controlling the tilt angle of the swash plate of the main hydraulic pump 12. In other words, the controller 9 controls the swash plate drive device 11 in response to the operation command from the operation device 5 to control the flow rate of the hydraulic oil discharged from the main hydraulic pump 12 and/or the absorption torque. The controller 9 controls a tilt rotation speed of the swash plate of the main hydraulic pump 12 by, for example, adjusting a gain or filtering.

When it is determined that the detected remaining amount of power stored in the power storage device 2 is equal to or less than a predetermined threshold, the controller 9 controls the work implement 105 such that the rise of the operation speed of the work implement 105 in response to the operation command is slowed. In other words, when it is determined that the detected remaining amount of power stored in the power storage device 2 is equal to or less than a predetermined threshold, the controller 9 controls the work implement 105 such that acceleration responsiveness of the operation speed of the work implement 105 in response to the operation command is slowed.

The predetermined threshold of the remaining amount of power is, for example, about 20%.

For example, slowing the rise of the operation speed of the work implement 105 in response to the operation command includes limiting an increase acceleration of the current supplied to the electric motor 4.

In the embodiment, when it is determined that the detected remaining amount of power stored in the power storage device 2 is equal to or less than the predetermined threshold, the controller 9 slows the change in the operation speed of the work implement 105 in response to the operation command, compared to a change in the operation speed of the work implement 105 when the remaining amount of power stored in the power storage device 2 is greater than the predetermined threshold. For example, it is assumed that the operation speed of the work implement 105 is increased to V in a period of time T in response to the operation command from the work implement operation lever 51 when the remaining amount of power stored in the power storage device 2 is greater than the predetermined threshold. In this case, if the remaining amount of power stored in the power storage device 2 has decreased to the predetermined threshold or less, the controller 9 slows the acceleration responsiveness such that increasing, to V, the operation speed of the work implement 105 in response to the operation command from the work implement operation lever 51 takes time T′ (T<T′). The time T′ may be a time such that the operator can feel the slowed acceleration responsiveness of the operation speed of the work implement 105 in response to the operation command from the work implement operation lever 51. For example, the time T′ may be about 10% or more longer than the time T.

In the embodiment, when it is determined that the detected remaining amount of power stored in the power storage device 2 is equal to or less than the predetermined threshold, the controller 9 may limit the rate of increase of the current supplied to the electric motor 4. More specifically, the controller 9 outputs, to the inverter 3, a control command signal for limiting an increase acceleration of the current value supplied to the electric motor 4. For example, if the work implement operation lever 51 is operated from a non-operation position to a full lever operation position by the operator, the controller 9 outputs, to the inverter 3, a motor control command signal associated with an increase acceleration of the current value supplied to the electric motor 4 that is smaller than that when the remaining amount of power stored in the power storage device 2 is greater than the predetermined threshold.

In the embodiment, when it is determined that the detected remaining amount of power stored in the power storage device 2 is equal to or less than the predetermined threshold, the controller 9 may decrease an acceleration rate of the rotation speed of the electric motor 4. More specifically, the controller 9 outputs, to the inverter 3, a control command signal for limiting an increase acceleration of the rotation speed of the electric motor 4. For example, if the work implement operation lever 51 is operated from a non-operation position to a full lever operation position by the operator, the controller 9 outputs, to the inverter 3, a motor control command signal associated with an increase acceleration of the rotation speed of the electric motor 4 that is smaller than that when the remaining amount of power stored in the power storage device 2 is greater than the predetermined threshold.

In the embodiment, when it is determined that the detected remaining amount of power stored in the power storage device 2 is equal to or less than the predetermined threshold, the controller 9 may limit a rate of increase of the flow rate of the hydraulic oil discharged from the main hydraulic pump 12. More specifically, the controller 9 outputs, to the swash plate drive device 11, a control command signal for limiting the tilt rotation speed of the swash plate of the main hydraulic pump 12. For example, if the work implement operation lever 51 is operated from a non-operation position to a full lever operation position by the operator, the controller 9 outputs, to the swash plate drive device 11, a control command signal for controlling the tilt angle of the swash plate of the main hydraulic pump 12 so as to limit the tilt rotation speed of the swash plate compared to when the remaining amount of power stored in the power storage device 2 is greater than the predetermined threshold.

When it is determined that the detected remaining amount of power stored in the power storage device 2 is equal to or less than a predetermined threshold, the controller 9 may notify the operator in addition to controlling the work implement 105 such that the rise of the operation speed of the work implement 105 in response to the operation command is slowed. For example, the controller 9 issues a notification that enables the operator to recognize that the remaining amount of power stored in the power storage device 2 is equal to or less than the predetermined threshold, that charging is recommended, or that operation response of the operation speed of the work implement 105 is slowed. The notification to the operator is issued based on the control command signal from the controller 9, by, for example, displaying on a monitor (not illustrated), outputting a sound from a speaker (not illustrated), or turning on a warning lamp (not illustrated).

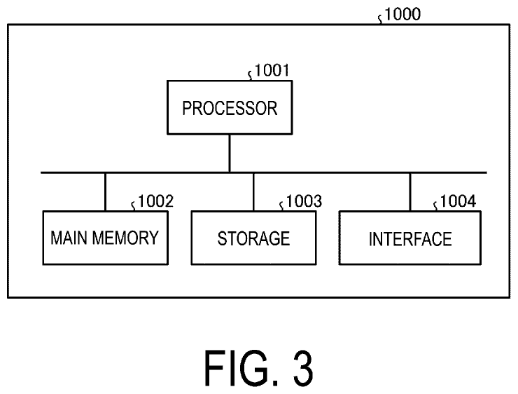

FIG. 3 is a block diagram illustrating a computer system according to the first embodiment. The controller 9 includes a computer system. The controller 9 outputs a command signal for controlling the work machine 100.

As illustrated in FIG. 3, the controller 9 includes a processor 1001, a main memory 1002, a storage 1003, and an interface 1004. The processor 1001 executes a computer program to perform arithmetic processing for operation of the work machine 100. Examples of the processor 1001 include a central processing unit (CPU) and a micro processing unit (MPU). The main memory 1002 is, for example, a non-volatile memory or a volatile memory. Examples of the non-volatile memory include a read only memory (ROM). Examples of the volatile memory includes a random access memory (RAM). The storage 1003 is a non-transitory tangible storage medium. The storage 1003 is, for example, a magnetic disk, a magneto-optical disk, a semiconductor memory, or the like. The storage 1003 may be an internal medium directly connected to a bus of the controller 9, or may be an external medium connected to the controller 9 via the interface 1004 or a communication line. The storage 1003 stores a computer program for controlling the work machine 100. The controller 9 is not limited to a single controller and may be divided into multiple controllers.

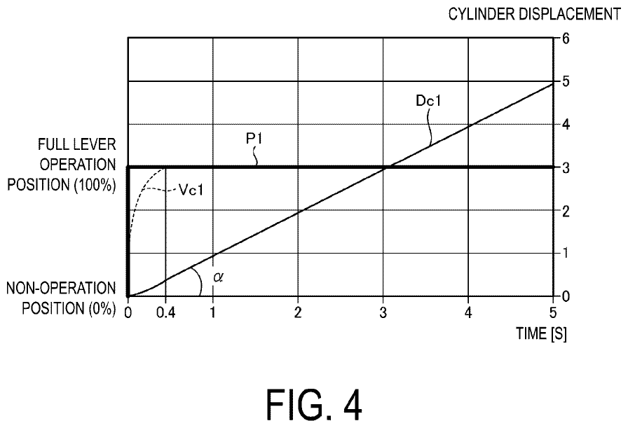

FIG. 4 is a diagram showing an example of work implement operation when the remaining amount of power stored in a power storage device has not decreased to a predetermined threshold, according to the first embodiment. FIG. 4 shows a relationship of a lever operation position P, a cylinder speed Vc1, and a cylinder displacement Dc1 when the remaining amount of power stored in the power storage device 2 has not decreased to the predetermined threshold, in other words, when the remaining amount of power stored in the power storage device 2 is greater than the predetermined threshold. As shown in FIG. 4, the time when the work implement operation lever 51 is operated from the non-operation position (0%) to the full lever operation position (100%) by the operator is 0 [s]. The cylinder speed Vel starts to increase immediately after the lever operation (0 [s]), and reaches a maximum speed at 0.4 [s].

As a result, after 0.4 [s], the cylinder displacement Dc1 linearly increases with a slope α. In the example shown in FIG. 4, at 5 [s], the cylinder displacement Dc1 reaches 5. When the remaining amount of power stored in the power storage device 2 is greater than the predetermined threshold, the controller 9 controls the work implement 105 such that the operation speed of the work implement 105 changes as shown by the cylinder speed Vc1.

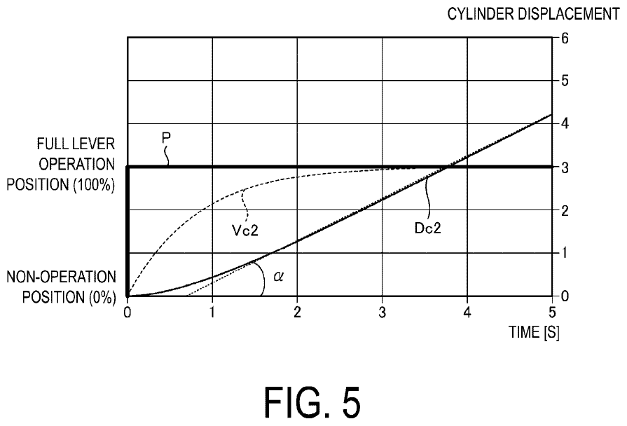

FIG. 5 is a diagram showing an example of work implement operation when the remaining amount of power stored in the power storage device has decreased to the predetermined threshold, according to the first embodiment. FIG. 5 shows a relationship of a lever operation position P, a cylinder speed Vc2, and a cylinder displacement Dc2 when the remaining amount of power stored in the power storage device 2 has decreased to the predetermined threshold, in other words, when the remaining amount of power stored in the power storage device 2 is equal to or less than the predetermined threshold. As shown in FIG. 5, the time when the work implement operation lever 51 is operated from the non-operation position (0%) to the full lever operation position (100%) by the operator is 0 [s]. The cylinder speed Vc2 starts to increase immediately after the lever operation (0 [s]), increases more slowly than the cylinder speed Vc1 shown in FIG. 4, and reaches a maximum speed at 3 [s]. As a result, the increase of the cylinder displacement Dc2 starting immediately after the lever operation is slower than that of the cylinder displacement Dc1 shown in FIG. 4. In the example shown in FIG. 5, after 3 [s], the cylinder displacement Dc2 increases linearly with the slope α. At 5 [s], the cylinder displacement Dc2 reaches 4.2. When the remaining amount of power stored in the power storage device 2 is equal to or less than the predetermined threshold, the controller 9 controls the work implement 105 such that the operation speed of the work implement 105 changes as shown by the cylinder speed Vc2.

### Control Method

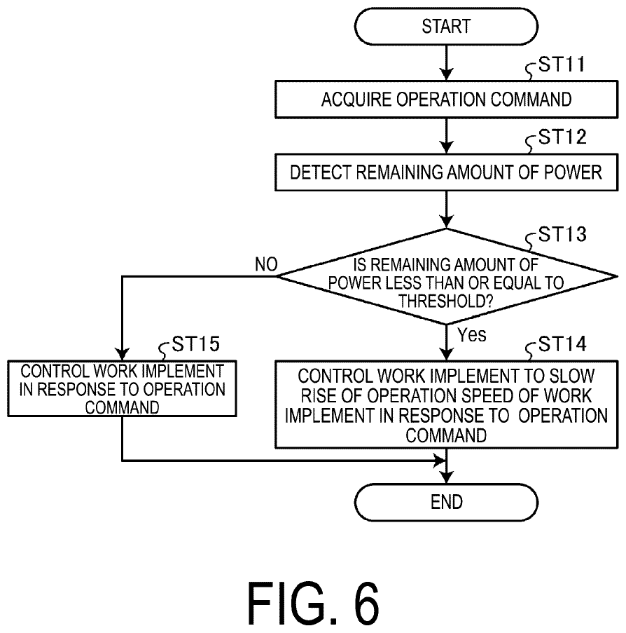

FIG. 6 is a flowchart illustrating an example of a method for controlling the work machine according to the first embodiment. The controller 9 acquires an operation command input from the operation device 5 (step ST11).

The controller 9 detects the remaining amount of power stored in the power storage device 2 (step ST12).

The controller 9 determines whether the remaining amount of power stored in the power storage device 2 is equal to or less than a predetermined threshold (step ST13). When the controller 9 determines that the remaining amount of power stored in the power storage device 2 detected in step ST12 is equal to or less than the predetermined threshold (Yes in step ST13), the method proceeds to step ST14. When the controller 9 determines that the remaining amount of power stored in the power storage device 2 detected in step ST12 is not equal to or less than the predetermined threshold (No in step ST13), the method proceeds to step ST15.

When the controller 9 determines that the remaining amount of power stored in the power storage device 2 is equal to or less than the predetermined threshold (Yes in Step ST13), the controller 9 controls the work implement 105 such that the rise of the operation speed of the work implement 105 in response to the operation command from the operation device 5 is slowed, and notifies the operator (Step ST14). More specifically, the controller 9 controls the work implement 105 so as to achieve a cylinder speed 2 as shown by the example of FIG. 5.

When the controller 9 determines that the remaining amount of power stored in the power storage device 2 is not equal to or less than the predetermined threshold (No in Step ST13), the controller 9 controls the work implement 105 in response to the operation command from the operation device 5 (Step ST15). More specifically, the controller 9 controls the work implement 105 so as to achieve a cylinder speed 1 as shown by the example of FIG. 4.

As described above, when it is determined that a detected remaining amount of power stored in the power storage device 2 is equal to or less than the predetermined threshold, a rise of the operation speed of the work implement 105 in response to an operation command is slowed, compared to when it is determined that the remaining amount of power stored in the power storage device 2 is not equal to or less than the predetermined threshold.

### Effects

As described above, in the embodiment, when it is determined that a detected remaining amount of power stored in the power storage device 2 is equal to or less than the predetermined threshold, the controller 9 controls the work implement 105 such that a rise of the operation speed of the work implement 105 in response to an operation command is slowed. The embodiment causes, when the remaining amount of power stored in the power storage device 2 has decreased to the predetermined threshold, a rise of the operation speed of the work implement 105 with respect to an operation amount of the operation device 5, such as the work implement operation lever 51, operated by the operator to be slowed. In the embodiment, when the remaining amount of power stored in the power storage device 2 is low, it is possible to prompt an operator to perform charging by providing a feeling that operation response is slowed. In the embodiment, when the remaining amount of power stored in the power storage device 2 is low, the operator can still continue the work although the operation response is slowed.

In the embodiment, when it is determined that a detected remaining amount of power stored in the power storage device 2 is equal to or less than the predetermined threshold, the controller 9 controls the work implement 105 such that a rise of the operation speed of the work implement 105 in response to an operation command is slowed, and notifies the operator. The embodiment makes it possible to notify the operator in addition to providing the operator with a feeling that operation response is slowed. The embodiment, when the remaining amount of power stored in the power storage device 2 is low, it is possible to more surely prompt the operator to perform charging.

In the embodiment, the controller 9 may output, to the inverter 3, a control command signal for limiting the rate of increase of the current supplied to the electric motor 4. The embodiment allows, when the remaining amount of power stored in the power storage device 2 has decreased to the predetermined threshold, a rise of the operation speed of the work implement 105 with respect to an operation amount of the operation device 5, such as the work implement operation lever 51, operated by the operator to be slowed.

In the embodiment, the controller 9 may output, to the inverter 3, a control command signal for decreasing an acceleration rate of the rotation speed of the electric motor 4. The embodiment allows, when the remaining amount of power stored in the power storage device 2 has decreased to the predetermined threshold, a rise of the operation speed of the work implement 105 with respect to an operation amount of the operation device 5, such as the work implement operation lever 51, operated by the operator to be slowed.

In the embodiment, when the remaining amount of power stored in the power storage device 2 has decreased to the predetermined threshold, it is possible to prompt the operator to perform charging, without decreasing the operation speed of the actuator, the rotation speed of the electric motor 4, and a maximum output. The embodiment causes, when the remaining amount of power stored in the power storage device 2 has decreased to the predetermined threshold, the operation speed of the actuator, the rotation speed of the electric motor 4, and the maximum output not to decrease, allowing the operator to continue the work although the operation response is slowed.

### First Variation of First Embodiment

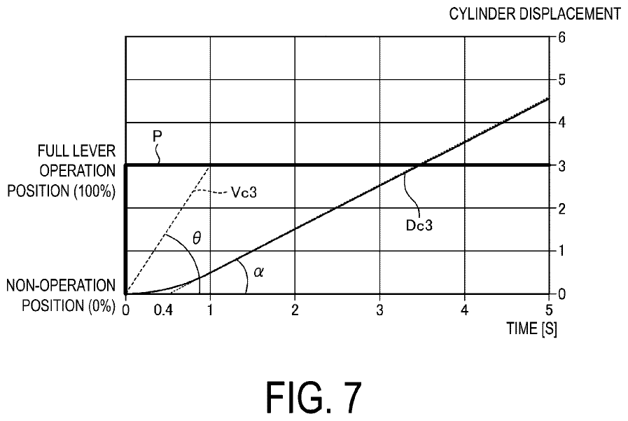

FIG. 7 is a diagram showing a variation of work implement operation when the remaining amount of power stored in the power storage device has decreased to the predetermined threshold. FIG. 7 shows a relationship of the lever operation position P, a cylinder speed Vc3, and a cylinder displacement Dc3 when the remaining amount of power stored in the power storage device 2 is equal to or less than the predetermined threshold. As shown in FIG. 7, the time when the work implement operation lever 51 is operated from the non-operation position (0%) to the full lever operation position (100%) by the operator is 0 [s]. The cylinder speed Vc3 starts to increase immediately after the lever operation (0 [s]), linearly increases with a slope θ for 1 [s], and reaches the maximum speed at 1 [s]. As a result, the increase of the cylinder displacement Dc3 starting immediately after the lever operation is slower than that of the cylinder displacement Dc1 shown in FIG. 4. In the example shown in FIG. 7, after 1 [s], the cylinder displacement Dc3 increases linearly with the slope α. At 5 [s], the cylinder displacement Dc3 reaches 4.5. When the remaining amount of power stored in the power storage device 2 is equal to or less than the predetermined threshold, the controller 9 may control the work implement 105 such that the operation speed of the work implement 105 changes as shown by the cylinder speed Vc3.

### Second Variation of First Embodiment

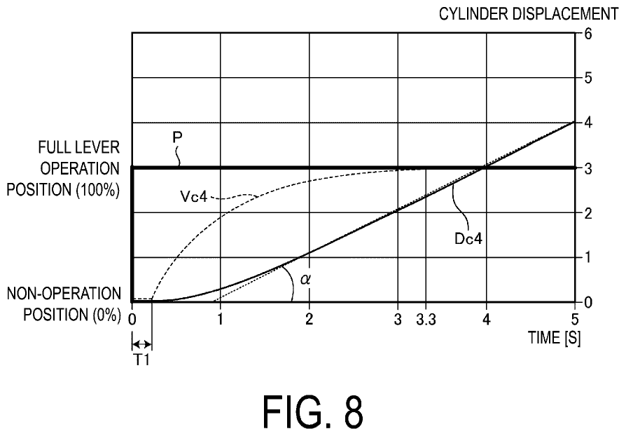

FIG. 8 is a diagram showing a variation of work implement operation when the remaining amount of power stored in the power storage device has decreased to the predetermined threshold. FIG. 8 shows a relationship of the lever operation position P, a cylinder speed Vc4, and a cylinder displacement Dc4 when the remaining amount of power stored in the power storage device 2 is equal to or less than the predetermined threshold. As shown in FIG. 8, the time when the work implement operation lever 51 is operated from the non-operation position (0%) to the full lever operation position (100%) by the operator is 0 [s]. The cylinder speed Vc4 is 0 in a time period from a time point immediately after the lever operation (0 [s]) to 0.3 [s]. After 0.3 [s], the cylinder speed Vc4 increases more slowly than the cylinder speed Vc1 shown in FIG. 4, and reaches the maximum speed at 3.3 [s]. Thus, the cylinder displacement Dc4 is 0 before 0.3 [s]. At 0.3 [s], the cylinder displacement Dc4 increases more slowly than the cylinder displacement Dc1 shown in FIG. 4. In the example shown in FIG. 8, in a time period T1 from 0 [s] to 0.3 [s], the cylinder displacement Dc4 is zero, and after 3.3 [s], the cylinder displacement Dc4 increases linearly with the slope α. At 5 [s], the cylinder displacement Dc4 reaches 4. When the remaining amount of power stored in the power storage device 2 is equal to or less than the predetermined threshold, the controller 9 may control the work implement 105 such that the operation speed of the work implement 105 changes as shown by the cylinder speed Vc4 after the time period T1 elapses.

### Third Variation of First Embodiment

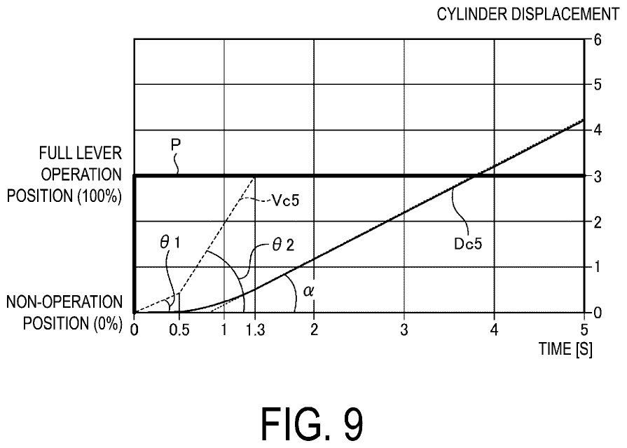

FIG. 9 is a diagram showing a variation of work implement operation when the remaining amount of power stored in the power storage device has decreased to the predetermined threshold. FIG. 9 shows a relationship of the lever operation position P, a cylinder speed Vc5, and a cylinder displacement Dc5 when the remaining amount of power stored in the power storage device 2 is equal to or less than the predetermined threshold. As shown in FIG. 9, the time when the work implement operation lever 51 is operated from the non-operation position (0%) to the full lever operation position (100%) by the operator is 0 [s]. The cylinder speed Vc5 linearly increases with a slope θ1 in a time period from a time point immediately after the lever operation (0 [s]) to 0.5 [s]. After 0.5 [s], the cylinder speed Vc5 increases linearly with a slope θ2 and reaches the maximum speed at 1.3 [s]. As a result, the increase of the cylinder displacement Dc5 starting immediately after the lever operation is slower than that of the cylinder displacement Dc1 shown in FIG. 4. In the example shown in FIG. 9, after 1.3 [s], the cylinder displacement Dc5 increases linearly with the slope α. At 5 [s], the cylinder displacement Dc5 reaches 4.2. When the remaining amount of power stored in the power storage device 2 is equal to or less than the predetermined threshold, the controller 9 may control the work implement 105 such that the operation speed of the work implement 105 changes as shown by the cylinder speed Vc5.

### Second Embodiment

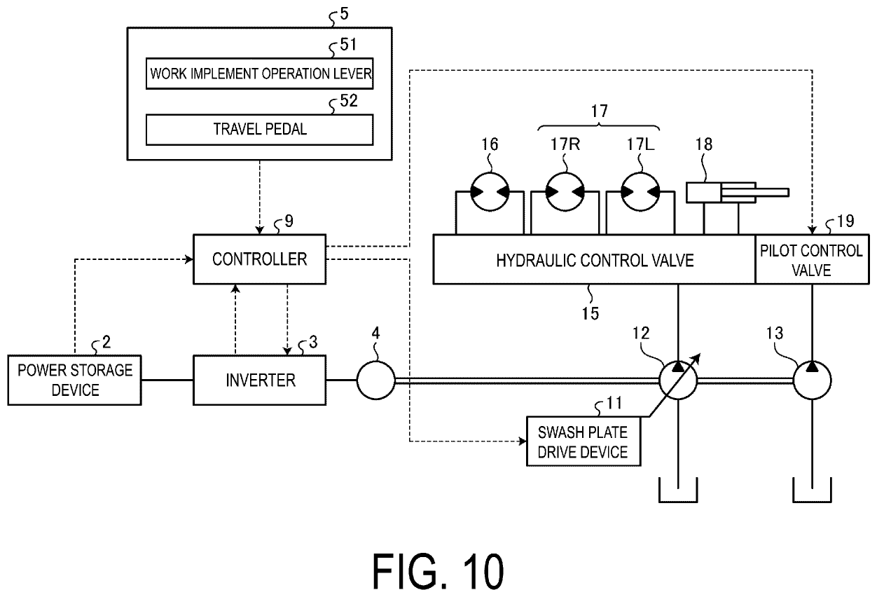

A second embodiment will be described with reference to FIG. 10. FIG. 10 is a diagram schematically illustrating a configuration for controlling a work machine according to a second embodiment. The second embodiment is different from the first embodiment in that a pilot control valve 19 is provided and the operation device 5 is an electric operation device. Components the same as or similar to those of the first embodiment are denoted by the same or corresponding reference signs, and description thereof will be omitted. The same applies to embodiments described later.

The pilot control valve 19 controls the hydraulic control valve 15.

The work implement operation lever 51 is an electric operation lever. The work implement operation lever 51 outputs, to the controller 9, an operation command indicating an operation amount of the work implement operation lever 51.

The travel operation pedal 52 is an electric operation pedal. The travel operation pedal 52 outputs, to the controller 9, an operation command indicating an operation amount of the travel operation pedal 52.

When it is determined that a detected remaining amount of power stored in the power storage device 2 is equal to or less than the predetermined threshold, the controller 9 controls the pilot control valve 19 such that the acceleration responsiveness of the operation speed of the hydraulic control valve 15 in response to the operation command is slowed.

In the embodiment, when it is determined that the detected remaining amount of power stored in the power storage device 2 is equal to or less than the predetermined threshold, the controller 9 outputs, to the pilot control valve 19, a control command signal for slowing the acceleration responsiveness of the operation speed of the hydraulic control valve 15.

### Effects

As described above, in the embodiment, the pilot control valve 19 is controlled such that the acceleration responsiveness of the operation speed of the hydraulic control valve 15 in response to an operation command is slowed. The embodiment allows, when the remaining amount of power stored in the power storage device 2 has decreased to the predetermined threshold, a rise of the operation speed of the work implement 105 with respect to an operation amount of the operation device 5, such as the work implement operation lever 51, operated by the operator to be slowed.

### Third Embodiment

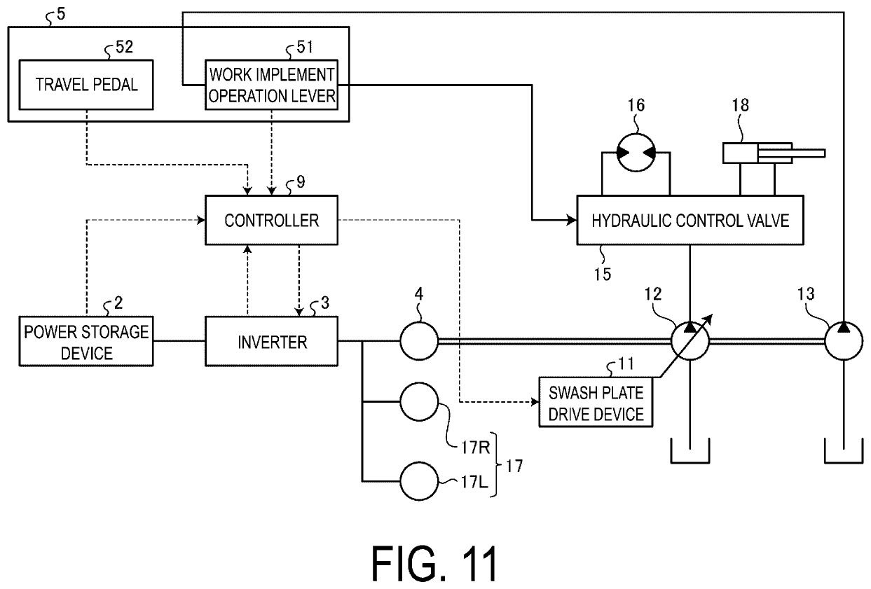

A third embodiment will be described with reference to FIG. 11. FIG. 11 is a diagram schematically illustrating a configuration for controlling a work machine according to a third embodiment. The third embodiment is different from the first embodiment in that the travel motor 17 is an electric motor and the travel operation pedal 52 is an electric operation pedal.

The travel motor 17 is driven by electricity from the power storage device 2.

The travel operation pedal 52 is an electric operation pedal. The travel operation pedal 52 outputs, to the controller 9, an operation command indicating an operation amount of the travel operation pedal 52.

The controller 9 controls the travel motor 17 in response to the operation command from the travel operation pedal 52 regardless of the detected remaining amount of power stored in the power storage device 2.

### Effects

As described above, in the embodiment, travel of the work machine 100 is controlled in response to the operation command from the travel operation pedal 52 regardless of the remaining amount of power stored in the power storage device 2. The embodiment allows, even when the remaining amount of power stored in the power storage device 2 has decreased to the predetermined threshold, the work machine 100 to travel the same as when the remaining amount of power stored in the power storage device 2 does not decrease to the predetermined threshold.

### REFERENCE SIGNS LIST

1 System, 2 Power storage device, 3 Inverter, 4 Electric motor (electrical motor), 5 Operation device, 9 Controller, 11 Swash plate drive device, 12 Main hydraulic pump, 13 Pilot hydraulic pump, 15 Hydraulic control valve, 16 Revolution motor, 17 Travel motor, 18 Cylinder, 51 Work implement operation lever (work implement operation device), 52 Travel operation pedal (travel operation device), 100 Work machine, 102 Travel body, 103 Revolution body, 104 Blade, 105 Work implement, 105A Boom, 105B Arm, 105C Bucket, 106 Operator seat, 109 Display device, 110 Support arm, 111 Pole, 112 Cab, 126 Work implement cylinder, 126A Boom cylinder, 126B Arm cylinder, 126C Bucket cylinder.

1. A system for controlling a work machine that includes a work implement and is driven by electricity from a power storage device, the system comprising:
an operation device configured to operate the work implement; and
a controller, wherein
the controller
acquires an operation command from the operation device,
detects a remaining amount of power stored in the power storage device, and
controls the work implement to slow a rise of an operation speed of the work implement in response to the operation command from the operation device when it is determined that the detected remaining amount of power stored in the power storage device is equal to or less than a predetermined threshold.

2. The system according to claim 1, wherein
the work machine comprises an electrical motor configured to operate the work implement, and
the controller limits a rate of increase of a current supplied to the electrical motor.

3. The system according to claim 1, wherein
the work machine comprises an electrical motor configured to operate the work implement, and
the controller decreases an acceleration rate of a rotation speed of the electrical motor.

4. The system according to claim 1, wherein
the work machine comprises a variable displacement hydraulic pump configured to supply hydraulic oil to the work implement, and
the controller limits a rate of increase of a flow rate of the hydraulic oil discharged from the variable displacement hydraulic pump.

5. The system according to claim 1, comprising an operation device configured to control travel of the work machine, wherein
the controller
acquires an operation command from the operation device configured to control travel of the work machine and
controls travel of the work machine in response to the operation command from the operation device configured to control travel of the work machine regardless of the detected remaining amount of power stored in the power storage device.

6. A work machine, comprising:
a work implement;
a power storage device;
an operation device configured to operate the work implement; and
a controller, wherein
the controller
acquires an operation command from the operation device,
detects a remaining amount of power stored in the power storage device, and
controls the work implement to slow a rise of an operation speed of the work implement in response to the operation command from the operation device when it is determined that the detected remaining amount of power stored in the power storage device is equal to or less than a predetermined threshold.

7. A method for controlling a work machine driven by electricity from a power storage device, the method comprising:
acquiring an operation command from an operation device configured to operate a work implement;
detecting a remaining amount of power stored in the power storage device; and
controlling the work implement to slow a rise of an operation speed of the work implement in response to the operation command from the operation device when it is determined that the detected remaining amount of power stored in the power storage device is equal to or less than a predetermined threshold.
